(19) United States
(12) Patent Application Publication
(10) Pub. No.: US 2022/0351360 A1
(43) Pub. Date: Nov. 3, 2022

(54) SYSTEM AND PROCESS FOR ONLINE DETERMINATION OF THE CHARACTERISTICS OF WORN BALLS AND BALL FRAGMENTS OF THE SAME

(71) Applicants: LMAGNE INGENIERÍA LTDA, Santiago (CL); SOCIEDAD DE INNOVACIÓN Y TRANSFERENCIA TECNOLÓGICA LTDA., Viña del Mar (CL); ESTUDIO, ASESORÍAS Y CAPACITACIÓN ALTOYA LTDA., Santiago (CL)

(72) Inventors: Gilda Verónica TITICHOCA AGUIRRE, Santiago (CL); Ennio Carlo PERELLI BACIGALUPO, Viña del Mar (CL); Germán Arnaldo SEPÚLVEDA VILLALOBOS, Viña del Mar (CL); Jaime Roberto DÍAZ CID, Viña del Mar (CL); Patricio Alejandro CASTILLO PIZARRO, Viña del Mar (CL); Eduardo Lorenzo ALTAMIRANO CABRERA, Santiago (CL)

(21) Appl. No.: 17/608,699

(22) PCT Filed: May 2, 2020
(86) PCT No.: PCT/CL2020/050048

§ 371 Date: Nov. 3, 2021

(30) Foreign Application Priority Data
May 3, 2019 (CL) 1231-2019

(51) Int. Cl. G06T 7/00; G06T 7/60; G06T 7/194; H04N 7/18; G06V 20/60; G06T 7/155; B02C 17/18; G05B 19/4155

(52) U.S. Cl. CPC G06T 7/0004; G06T 7/60; G06T 7/194; H04N 7/183; G06V 20/60; G06T 7/155; B02C 17/1805; G05B 19/4155; G06T 2207/20036; G06T 2207/30136; G06T 2207/30242; G05B 2219/37355

(57) ABSTRACT

The present invention relates to a system and process carried out after a process of separating fragments of steel from pieces of ore that come out of a semi-autogenous grinder for grinding ores, and which consists of a system formed by one or more instruments for capturing images, each one being sensitive to light of different wavelengths, which point to the surface of an element for receiving the steel fragments or a channel that receives the steel balls and the fragments thereof from the separation process, through which the steel balls and fragments thereof move when they are discharged from this process, with the possibility of directing each image sensor such that it is not parallel to the others.

By digitally processing the images obtained with the one or more sensors, the dimensions and morphology of the balls and ball fragments discharged from the separation process can be determined.

### TECHNICAL FIELD OF THE INVENTION

The present invention is developed in the field of operation, monitoring and control of mining mills, specifically it refers to a system and a process to determine online the characteristics of worn balls and the fragments thereof, which have been ejected. of a semi-autogenous mineral grinding mill (SAG) in a material that includes the ground ore and that are discharged in free fall into a chute from one or more magnets, for example electromagnets, that capture worn balls and the fragments of steel from the same from the ejected material, where said electromagnets are suspended on a conveyor belt on which the ejected material goes.

### BACKGROUND OF THE INVENTION

The semi-autogenous mineral grinding mills (1) are machines, which basically consist of a rotating drum with horizontal axis, which has an inlet (6) of ore (load) to be ground at a first end and an outlet (7) of the ground ore (filler) that has reached the desired size, through a second end. Through the inlet (6) there are also added metal grinding media, generally spherical in shape and preferably made of steel, corresponding to the grinding balls. In the case of wet grinding, water is also added, in this way, the internal load of the semi-autogenous mill is composed of grinding balls, ore and water (8) that are in permanent movement in the grinding chamber (2) while the semi-autogenous mill rotates. In FIGS. 1 to 3, it is observed that the internal load (8) of the semi-autogenous mill (1) is composed of ore (10), balls (9) and water for the case of wet grinding. Both the ore and the balls of the internal load (8) inside the grinding chamber (2) decrease in size as a result of the movement caused by the rotation of the semi-autogenous mill (1), where the ore (10) and the balls (9) when falling, suffer blows that cause fracture of the ore (10), as well as abrasion due to the relative movement between the components, in addition to attrition when the ore (10) particles are simultaneously subjected to frictional and compression forces by the moving load. When the ore (10) contained in the load (8) reaches a predetermined size, it passes through the grooves (5) of a grate (4) from the grinding chamber (2) to the discharge chamber (3), and then leave the semi-autogenous mill (1) through the load outlet (7) to the classifying screens or trommels (14). In the external classifier of the mill (screen or trommel) the separation of fine ore takes place, which advances to another stage of size reduction, and coarse ore, called pebbles, which is sent to a conveyor belt (15).

One of the important elements of a semi-autogenous mineral grinding mill is the internal grate (4), which has a plurality of grooves (5) separated by ribs (35), which have an opening with a predetermined size, so that the ore (10) that has reached this size leaves the semi-autogenous mill (1). The balls (9) used as grinding elements in the semi-autogenous mill (1), when added to the semi-autogenous mill, have a size greater than the opening of the groove (5). As the mineral grinding process occurs, the balls (9) wear out by abrasion and decrease their diameter, becoming smaller balls (11) that reach the size of the groove (5) opening and, therefore, also pass to the discharge chamber (3) and then to the outlet (7), leaving the semi-autogenous mill (1) towards the classifiers (14), or towards a conveyor belt (15). Also, during the grinding process, there are balls (9) that break, and thus, these broken balls (12) also reach a sufficient size to pass through the opening of the groove (5), as shown in FIG. 3. With the above, from the semi-autogenous mill (1) the ground ore (10), the worn balls (11) and the fragments of broken balls (12) come out, as well as water when it comes to wet grinding.

During the operation of the semi-autogenous mill, the grate (4) can also suffer the fracture of one of its ribs (35), as shown in FIGS. 4 and 5. Thus, the exposed opening corresponds to two communicating grooves (5) generating a larger opening (13), through which ore (10) can pass and balls (9) of a larger size than in normal condition should remain in the grinding chamber (2). This problem can be seen in FIG. 5 of the prior art. The fracture of the grates can also occur in other areas, such as, for example, in a corner, also generating grooves with larger openings, as shown in FIG. 7. Like those already mentioned, there is the possibility that the fracture of the grate happens in different ways.

The kinetic energy provided by the rotary movement of the semi-autogenous mill to the internal load, undergoes several transformations during the process. This is the main energy that has the internal load (8), ore, water and grinding elements. Part of it is transformed into heat energy that is acquired by water, ore (10) and balls (9), and mainly these last two since they are more time inside the grinding chamber (2), until they are reduced in size to leave the semi-autogenous mill (1). Of these two, the grinding elements (9) are in the grinding chamber (2) for a much longer time than the ore (10), reaching periods of 20 to 40 days or more, depending on the process conditions, the refill ball size and grate opening size. For this reason, grinding elements have a greater boost in heat energy.

Likewise, under certain conditions, the energy produced by the impacts of the balls (9) is large enough for them to fracture or break and leave the grinding chamber (2) of the semi-autogenous mill (1) as a broken ball (12), such as explained in FIGS. 3 and 6.

Following the grinding process, ore and steel pieces come out from the semi-autogenous mill, which reaches the external classifier, which allows the separation of the fine ore and the coarse fraction that contains both ore (pebbles) and balls and/or larger ball fragments, which follow the conveyor belts to subsequent processes. In general, the pebbles are reduced in size using cone crushers that are damaged if steel elements are present in the feed, leading, for example, to the fracture of their components, causing them to be stopped for the corresponding repair. This condition forces the worn balls, the larger balls that have come out through a slot with a broken rib, and the broken balls to separate from the ore, because these fragments of steel balls are not desired during the process.

To separate worn steel balls and broken steel balls, there are known methods of separating worn steel balls and fragments of broken balls from the ore using magnets placed on the conveyor belt that transport the coarse fraction of the product from the semi-autogenous mill (called pebbles) that are generally larger than ½ in. (1.27 cm). One of the most used methods includes using electromagnets to capture the steel balls and fragments of broken balls, separating them from the ore that leaves the semi-autogenous mill, to later unload them to be deposited in collection bins and/or tanks located under the conveyor belt.

From the point of view of the efficiency of the grinding process, it is important to keep the mass of steel corresponding to whole balls (9) stable in the grinding chamber (2), so that the uncontrolled output of balls (9) by wear or tear of the same or by the fracture of the grate (13) are events that must be detected in the shortest possible time to take control actions.

That is why the need arises to know in the most exact way possible the amount of grinding elements that come out of the semi-autogenous mill, and the mass of each of these elements, in order to replace the balls necessary to keep constant either their quantity or the sum of the mass of balls in the grinding chamber, in addition to knowing if they come out as spent or broken balls, which will allow action to be taken on the grinding process, and in the longer term on the quality of the balls.

In the state of the art there have been attempts to solve part of this problem. Thus, for example, document WO 2016/000024 discloses a monitoring device in the form of a camera in a protection casing that is fixed to a structure at the outlet of the feed chute and in a particular embodiment to a flange that is extends outwardly over the outlet structure. The flange is also compatible with a light also in a protective housing. The feed chute feeds the ore into a mill. The camera and light housings contain a viewing window that is flushed by water jets and the window is protected by a visor that can be opened when the interior of the mill is to be recorded. The arrangement allows characterizing the load inside the mill to be monitored while the mill is free of vapors and stopped or moving slowly. This solution makes it possible to identify the steel balls only when they are in contact with the surface.

Document WO 2013/067651 discloses a direct visual monitoring system for sensing the interior of a rotary mill, comprising a monitoring unit, a main control unit and an operation and management unit, where the monitoring unit is located inside a feed hopper and is adjusted according to the physical characteristics of said feed hopper and the dimensions of the mill, to allow a direct view of the inside of the mill. The operating method comprises having inside the monitoring unit, a container of sensors to sense its interior temperature; determine the acceleration in the vertical axis, in the lateral horizontal axis and in the frontal horizontal axis, as a function of time; acquire two-dimensional images of the geometric conditions inside the mill; acquire two-dimensional thermal images of the interior of the mill; and executing a distance detection on one or more planes. A problem with this solution is that it does not allow to identify or characterize the worn balls or fragments of the balls that are inside the mill. Another problem with this solution is that it does not allow to determine the damage in the internal grate but only in the mill liners.

Document WO 2007/124528 discloses a method of monitoring a SAG (semi-autogenous) grinding mill or an AG (autogenous) grinding mill. The method of monitoring the mill involves generating an image of the position of the load inside the mill in real time when it is rotating. The method further includes the use of a processor to build an image of the load inside the mill, while the load is falling, in order to determine which phase is in contact with the inner wall of the mill drum in the regions that are detected. This solution allows to identify when the steel balls are in contact with the inner wall, however, it does not allow to identify or characterize the worn balls or fragments of the balls that are inside the mill.

Another solution to be considered is that described in patent application CL 574-2017, in the name of the applicant, which discloses a system for detecting worn balls, broken balls and ore outside the mill on the surface of a screen of a sieve or trommel that retains the larger material coming out of a semi-autogenous mill or a conveyor belt through a system comprising infrared spectrum cameras and visual spectrum cameras, which include their respective transmission media. This solution makes it possible to identify and characterize the worn balls or fragments of the balls that are mixed with the ore expelled from the semi-autogenous mill, however, the disclosed configuration does not allow it to be physically possible to make the detection in any arrangement of the elements used to the exit of the semi-autogenous mill. Another possible problem with this solution is that if the thermal energy acquired by the steel balls and their fragments is not sufficiently greater than that acquired by the ore, then the identification and characterization of the balls, larger ball pieces and mineral could lose precision.

Prior art solutions disclose monitoring devices and methods that allow characterizing the loading conditions both inside and outside the mill, such as on the surface of the external ore classifier or on the conveyor belt that removes the ore particles, and balls of sizes larger than the groove of the external classifier screen. A prior art solution considers the identification and characterization of the worn balls or fragments of the balls leaving the mill. However, none of the disclosed solutions allows to identify the steel balls and their fragments at a stage after the conveyor belt when the steel balls are separated from the rest of the ore. For this, the present invention proposes a receiving element whose surface is a screen, from which emanates the information for the system, which receives the worn balls and broken balls from the free fall when they are discharged from the electromagnet located on the conveyor belt, said receiving element comprising a channel that serves to detect the balls and fragments of balls, being able to characterize them in shape and size using image capture and processing devices.

### DESCRIPTION OF THE INVENTION

The present invention refers to a system and process that acts downstream of a separation process between the steel pieces and the fragments of the ore that come out of a semi-autogenous mill for the grinding of minerals and that consists of a system comprising one or a plurality of instruments for capturing images, such as, for example, digital cameras, each sensitive to light of different wavelengths, such as the visual spectrum, which are pointed towards the surface of a receiver element of the steel pieces or chute that receives the steel balls and their pieces from the separation process, such as, for example, a chute through which the steel balls and their fragments move when they are discharged from this process, and with the possibility of orienting each sensor image in a way not parallel to the others. By digitally processing the images obtained with the sensor (s), the dimensions and morphology of the balls and ball fragments that are discharged from the separation process are determined. These image sensors, or digital cameras, capture the image in their operating spectrum, which is recorded in the memory of a data processing means of the system.

With the present invention, it will be possible to identify the fragments of balls that come out from a semi-autogenous mill and that are separated from the ore in a subsequent process, and to characterize by size the fragments of balls that are discharged from this process and that slide or roll on the surface of the receiver element or chute. It will also be possible to quantify the amount of steel that comes out from the inside of the mill, classifying them, in addition, as balls worn by abrasion, that is, those that come out as rounded pieces and, on the other hand, the broken balls, or in general, in any new morphological class that is of interest for the operational evaluation of the mill and for the analysis of the quality of the grinding media.

The present invention will help in the management of the internal ball loading in SAG mills, as well as to manage the steel consumption as grinding media, since it will provide online information to make the decision to reload new balls according to the fragments of balls that are separated from the ore that comes out of the mill. It will also allow to establish corrective actions, since, if excessively worn or broken balls come out, it is possible to evaluate and manage improvements in the quality of the grinding media or in the operating conditions, both factors that can be the cause of accelerated wear or massive breakage of grinding media.

Additionally, the system and process of the present invention will be able to indirectly infer the breakage of one or more grates, by observing that the exit rate of grinding media of size greater than the average of the past few hours increases.

### BRIEF DESCRIPTION OF THE DRAWINGS

The drawings are included to provide a further understanding of the invention and form part of this description and further illustrate some of the preferred embodiments of this invention.

FIG. 1 shows a cross section of a prior art semi-autogenous mineral grinding mill, which works by rotating on its axis to produce ore size reduction.

FIG. 2 shows a longitudinal section of a prior art semi-autogenous mineral grinding mill.

FIG. 3 shows the schematic of a prior art grate with the charge within the semi-autogenous mill passing through it.

FIG. 4 shows an enlargement of a perspective view of a grate that has a fracture, causing a hole through which larger balls and ore escape and that should remain in the grinding chamber.

FIG. 5 shows a longitudinal section of a prior art semi-autogenous mineral grinding mill, where the grate has suffered a fracture of one of its ribs.

FIG. 6 shows a diagram of the exit of a ball of maximum size added to the mill through the hole caused by the fracture of the grate, and pieces of ore of a larger size can also exit.

FIG. 7 shows an enlargement of a perspective view of a grate that has a fracture in one of its corners, causing a hole through which larger balls and ore escape and that should remain in the grinding chamber.

FIG. 8 shows a schematic view of a mill, a classifier and a conveyor belt, carrying worn steel balls and fragments of steel balls together with ore.

FIG. 9 shows a schematic view of the elements that can be constitutive of the system, to identify, quantify and characterize worn balls and broken balls that are discharged from the separation process with magnets, for example electromagnets.

FIG. 10 shows a flow chart of the steps that are performed in one of the embodiments of the process of the present invention.

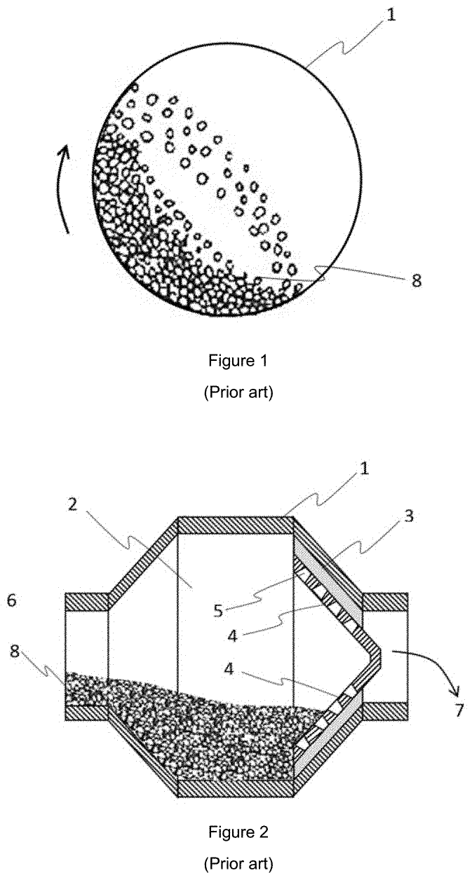

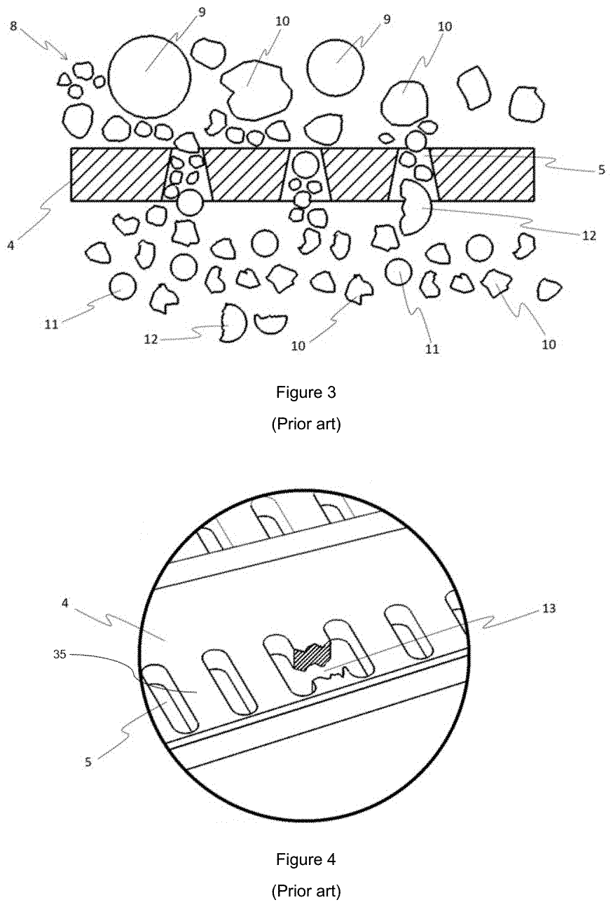

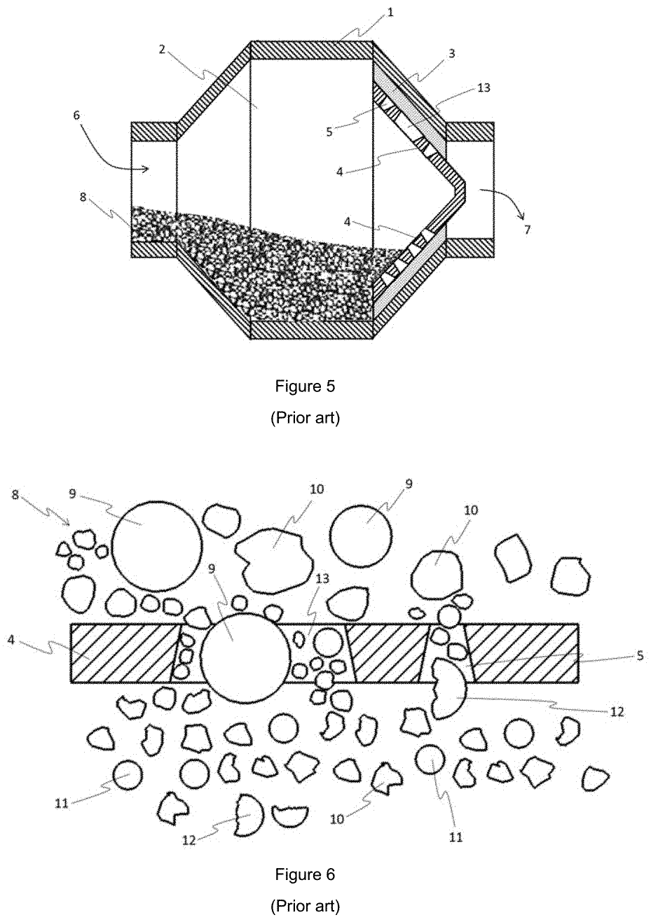

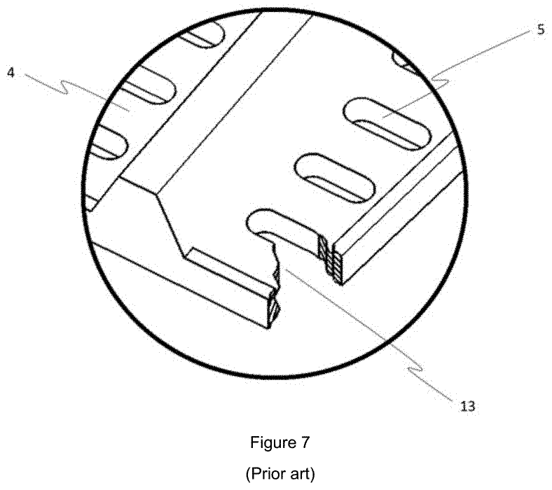

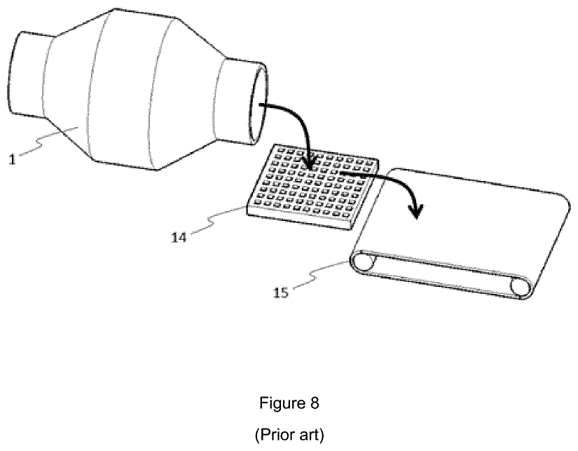

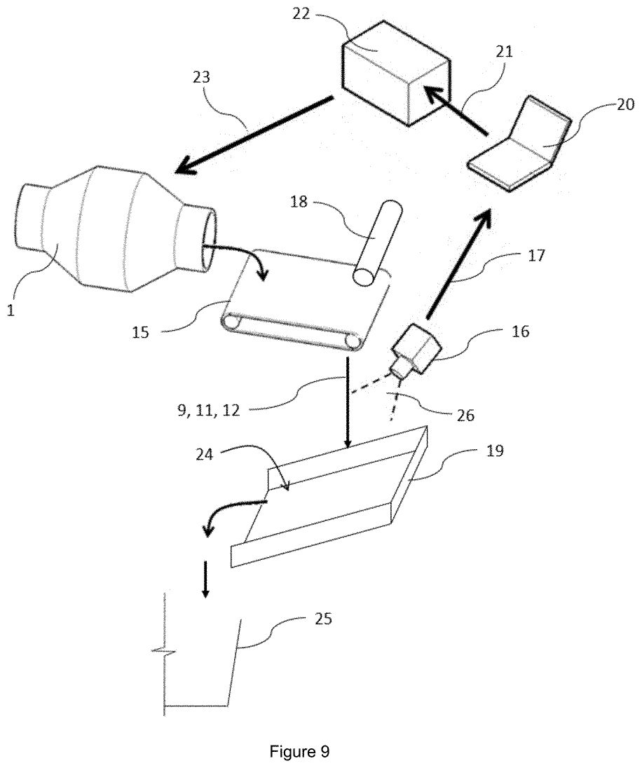

### DETAILED DESCRIPTION OF THE INVENTION

The present invention refers to a system that works associated with a semi-autogenous mill (1) for ore grinding. The system is installed outside the semi-autogenous mill (1) in an area after the separation process of the steel balls and their fragments from the ore coming out of the semi-autogenous mill (1), which allows observing the surface of a receiving element or chute (19) that receives the discharge from the separation process. From the semi-autogenous mill (1) comes out a material composed of steel balls, fragment of balls and ore after the grinding process, where said material is on a conveyor belt (15) in which acts on the conveyor belt (15) one or more magnets, for example electromagnets (18) suspended on the conveyor belt that capture the balls and fragments of steel that go along with the ore on the conveyor belt (15) from the belt itself. The balls and fragments of steel separated on the conveyor belt (15) by the electromagnets (18) are subsequently discharged in free fall into collection containers and/or bins (25) located below the conveyor belt (15). In the present invention, a receiving element or chute (19) is inserted which receives said balls and fragments of steel captured by the electromagnet(s) on its surfaces before free fall when the electromagnets are discharged, said chute (19) serving as a screen for the detection of balls and fragments of balls, being able to characterize them in shape and size. The chute (19) is necessary in a length that allows the detection of the balls and fragments of balls for an adequate characterization where said length is such that the balls roll on its surface and the fragments of ball can slide and fall without accumulating.

As shown in FIG. 9, in order to observe the surface of the chute (19), at least one high resolution visual spectrum digital camera (16) is located to determine the dimensions of the oversize balls and ball fragments exiting the semi-autogenous mill. The images obtained with the high-resolution visual spectrum camera (16) are used to determine the dimensions of the balls and larger sized ball fragments that come out of the semi-autogenous mill, since a visual spectrum camera can provide a higher resolution. These cameras are digital cameras that capture the image, either from the infrared spectrum or from the visual spectrum, being recorded in the memory of the data processing means (20).

The visual spectrum camera (16) has visual spectrum image data transmission means (17), whether wired or wireless. The data transmission means (17) transmits the data to the data processing means (20), being a processor, a PC computer, a PLC programmable logic controller or the like. The data processing means (20) have means for receiving (not shown) the data sent by at least one camera (16).

The surface of the receiving element of the balls and fragments of balls, for example, of a chute (19) constitutes a fundamental element of this invention. This surface is a screen (24) from which the information for the system emanates. At least one visual spectrum camera (16) is installed pointing towards the surface of the screen (24) of said chute (19) to capture and record the image of the balls and fragments of balls that roll or slide on the surface of the screen (24) of the chute (19) and transmit it with the visual spectrum image data transmission means (17), starting the counting of the balls and fragments of balls discharged from the separation process. This count also discriminates between worn (rounded) and broken (irregularly shaped pieces) balls. To do this, the visual spectrum camera (16) is used that captures and records a high resolution image of the balls (9) showing the contour and size of the worn and broken balls.

The data processing means (20) processes the visual spectrum image data and transmits the processed data by control data transmission means (21) as information to a control center (22), which determines the actions to be taken, depending on the information delivered by the data processing means (20). The control center (22) sends corrective instructions (23) to a control means or to the semi-autogenous mill operator (1), to correct the problem reported by the data processing means (20).

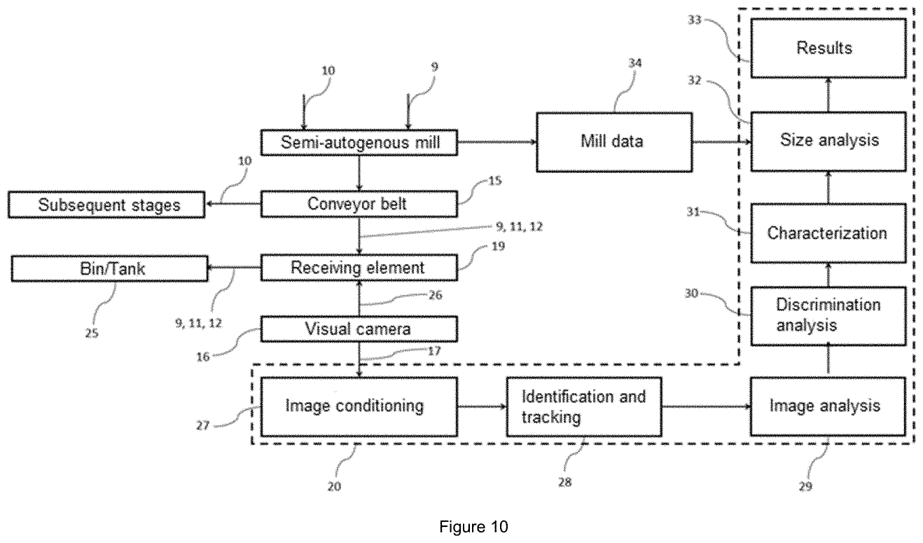

As shown in the flow chart in FIG. 10, the digital processing performed by the data processing means (20) starts in the image conditioning module (27), in which background subtraction, intensity adjustment and morphological operations are performed. Then, in the identification and tracking module (28) the balls and fragments of balls are tracked and an operation is performed in an image analysis module (29) by morphology and dimensions.

The load flow (8) conformed by the ore (10) and the balls (9), which passes through the grooves (5) of the internal grates (4) of the semi-autogenous mill (1), reaches the conveyor belt (15), where at least one electromagnet (18) captures the balls and fragments of steel that go on said conveyor belt (15) allowing said balls and fragments of steel to be separated from the ore (10) that is transported as a whole in a separation process. The balls and fragments of steel are discharged from said at least one electromagnet (18) and reach the surface of the screen (24) of the chute (19), where at least one visual spectrum camera (16) takes a set of visual images (26). Said at least one visual spectrum camera (16) sends the visual images (26) captured through visual spectrum transmission means (17) towards the data processing means (20).

The images (26) sent through the transmission means (17) are received in an image conditioning module (27), where said captured images (26) are processed. In the module (27) an image conditioning is carried out, where the geometry of the balls (9, 11) and fragments of balls (12) is subtracted with respect to the background, leaving only the image of the worn balls and the broken balls. In this same module (27) the intensity of the image is adjusted to perform the morphology determination operations of the balls (9, 11) and fragments of balls (12). The information generated in the module (27) is transferred to the module (28) of identification and tracking of the elements on the chute (19), whose images have already been conditioned. The information of the balls identified and tracked on the chute (19) is sent to a module (29) where they are analyzed using morphology and sizing determination techniques. The information from this analysis is sent to a discrimination analysis module (30) where the balls (9, 11) and fragments of balls (12) are differentiated.

The process continues through the characterization module (31) where the worn balls or fragments of balls are counted, characterizing the sizes and shapes of the balls (9, 11) and fragments of balls (12), that is, of the metal that is on the chute (19). From this analysis, the volume of the worn balls and fragments of broken balls is determined, and once the density of the steel is known, the mass of steel that leaves the semi-autogenous mill (1) is determined, and that can be delivered punctually or as mass flow by setting a period of time, such as per hour. Thus, it is possible to know online and in real time the approximate amount of metal that comes out from the semi-autogenous mill (1).

In the size analysis module (32), balls and fragments of balls are analyzed according to the size of the grate groove. This dimensional analysis corresponds to comparing the size of the worn balls and the fragments of broken ball with the size of the grate groove and if the former are larger, it is deduced that a fracture of the internal grate has occurred. The size of the hole produced can be determined by measuring the largest size of worn balls and fragments of broken ball on the chute (19).

For this purpose, in the analysis module (32), an analysis is performed to obtain the groove sizes of the grates from the maximum ball size. The analysis is performed using grate groove size data, reload ball size (new ball added to mill), and process data, conjugated with mill data such as speed, power, weight (obtained from load cells and/or oil pressure in breaks) and noise, previously loaded in a mill data module (34). The reload ball size can be entered by the mill operator and process data can be obtained directly in connection with the semi-autogenous mill operational control system (1).

The module (33) delivers the results of the previously described process, providing information on the output rate of balls and fragments of balls. In the event that the size of the balls is greater than the size of the internal grate groove used, an alarm will be issued for this anomaly. In the same way, if the number of balls in the chute (19) is greater than a preset value or range of values, the system will issue an alarm for this anomaly, so that in the control center (22) a means of control or mill operator take the necessary corrective action for the grinding process. The same happens when there is an excess of broken balls on the chute (19), activating an alarm.

A sharp decrease in the amount of balls and ball fragments on the chute (19) may indicate a malfunction of said at least one electromagnet (18) acting on the conveyor belt (15) which may result in clogging of crushers used to reduce the size of the pebbles preventing them from being returned to the semi-autogenous mill or sent to the ball mills, which corresponds to the subsequent size reduction stage. A sharp increase in the number of balls and ball fragments on the chute (19) can indicate poor ball quality that may result in excessive wear or breakage or indicate an operating condition that results in damage to the ball load.

1. A system for detecting worn balls and broken balls discharged from a conveyor belt (15) that receives the oversize material coming out of a semi-autogenous mill (1), where the worn balls and broken balls are separated from said material by at least one magnet, electromagnet (18), acting on the conveyor belt (15), wherein said system comprises:
a receiving element (19) whose surface is a screen (24) that receives the worn balls and broken balls when discharged from the electromagnet (18) acting on the conveyor belt (15);
at least one visual spectrum camera (16) which captures and records a set of visual images (26), from the surface of said receiving element (19);
visual spectrum image data transmission means (17) connected to said at least one visual spectrum camera (16);
data processing means (20) with receiving means receiving the visual spectrum image data (17) for processing and generating control data (21);
control data transmission means (21) connected to said data processing means (20); and
a control center (22) that receives the control data (21) to send corrective instructions (23) towards a control means or operator of the semi-autogenous mill (1).

2. The system for detecting worn balls and broken balls, according to claim 1, wherein the receiving element (19) is a chute.

3. The system for detecting worn balls and broken balls, according to claim 1, wherein the data processing means (20) is a conventional processor.

4. The system for detecting worn balls and broken balls, according to claim 1, wherein the data processing means (20) is a PC computer.

5. The system for detecting worn balls and broken balls, according to claim 1, wherein the data processing means (20) is a Programmable Logic Controller, PLC.

6. The system for detecting worn balls and broken balls, according to claim 1, wherein the visual spectrum image data transmission means (17) are wired.

7. The system for detecting worn balls and broken balls, according to claim 1, wherein the visual spectrum image data transmission means (17) are wireless.

8. The system for detecting worn balls and broken balls, according to claim 1, wherein the processing means (20) comprise:
an image conditioning module (27) for conditioning the image by subtracting the geometry of the balls (9, 11) and the ball fragments (12) from the background, performing an intensity adjustment and performing morphological operations;
an element identification and tracking module (28);
an image analysis module (29) for determining the morphology and dimensions of the balls (9, 11) and ball fragments (12);
a discriminating module (30) of balls and fragments of balls;
a characterization module (31) where worn balls or fragments of balls are counted, characterizing the sizes and shapes of the balls and fragments of balls (9, 11, 12);
an analysis module (32) where the groove sizes of the semi-autogenous mill grates are obtained from the maximum size of balls; and
a results module (33) where the output rate of balls and fragments of balls is obtained, with the functionality of emitting an alarm for an anomaly in the size of the balls and fragments of balls and an alarm for an anomaly in the amount of balls and fragments of balls.

9. A process for detecting worn balls and broken balls being discharged from a conveyor belt (15) that receives the oversize material coming out of a semi-autogenous mill (1), where the worn balls and broken balls are separated from said material by at least one electromagnet (18) acting on the conveyor belt (15), wherein comprises the following steps:
(a) capturing and recording visual spectrum images (26) from the screen surface (24) of a receiving element that receives the worn balls and broken balls from the conveyor belt (15);
(b) transmitting the captured visual spectrum images (26) through visual spectrum image data transmission means (17), to a data processing means (20);
(c) conditioning the images by an image conditioning module (27), comprising processing said captured images (26) by:
(c1) subtracting the image background, to leave only the image of the worn balls (9) and the broken balls (12);
(c2) adjusting the intensity of the images obtained in step (c1); and
(c3) performing the operations of determination of morphology of the balls and of the pieces of balls;
(d) performing the identification of the fragments of broken balls (12) and the worn balls (9) on the surface of the screen (24) of the receiving element (19) in an element identification and tracking module (28) using the images conditioned in step (c);
(e) analyze the morphology and dimensions in an image analysis module (29);
(f) perform a characterization of the worn balls (9) and the fragments of broken balls (12) in a characterization module (31), counting the pieces of metal, characterizing the sizes and characterizing the shapes;
(g) performing an analysis of the mill operating conditions in an analysis module (32), using the data of grate groove size, reload ball size and process data, conjugated with the data of the mill such as speed, power, weight and noise, previously loaded into a mill data module (34); and
(h) display process results in a results display module (33) showing the output rate of worn balls and fragments of broken balls, with the functionality of emitting an alarm due to an anomaly in the size of the identified worn balls, an alarm for an anomaly in the number of balls and fragments of balls detected and an alarm for an anomaly due to the shape of the fragments of balls.
